(19) United States
(12) Patent Application Publication
(10) Pub. No.: US 2001/0044749 A1
(43) Pub. Date: Nov. 22, 2001

(54) Home improvement system

(76) Inventors: Michael Heisler, Tucson, AZ (US); James Thevenot, Tucson, AZ (US)

Correspondence Address: Snell & Wilmer L.L.P., One Arizona Center, 400 East Van Buren, Phoenix, AZ, 85004-2202, US

(21) Appl. No.: 09/797,129

(22) Filed: Mar. 1, 2001

Related U.S. Application Data
(60) Provisional application No. 60/186,134, filed on Mar. 1, 2000.
(60) Provisional application No. 60/186,135, filed on Mar. 1, 2000.

(51) Int. Cl. G06F 17/60

(52) U.S. Cl. 705/26

(57) ABSTRACT

A method and system for the complete design and identification of materials and tools for home improvement projects that can be used in the convenience of the home. A web-site is suitably configured to provide for an on-line, interactive home improvement system. In this context, a home improvement system contemplates a system which enables an idea to be realized into a design and then information with respect to how to build the design, the materials needed to complete the project, and information on purchasing those materials provided to the user.

### CROSS-REFERENCE TO RELATED APPLICATIONS

This application claims the benefit of U.S. Provisional Application No. 60/186,134, filed Mar. 1, 2000, and U.S. Provisional Application No. 60/186,135, filed Mar. 1, 2000.

### BACKGROUND

1. Field of the Invention

The present invention generally relates to a home improvement system, and more particularly, to an interactive home improvement system accessed at home via the Internet.

2. Description of the Related Art

A common sight on weekends is the crowd of consumers at various hardware and home improvement stores across the country. These “weekend warriors” tackle home improvement projects of varying scope and complexity in their weekend spare time. Typically, a weekend warrior will buy a majority of the materials and tools for a home improvement project in an initial purchasing mission at a first store. The weekend warrior will then proceed to their home to take on the improvement project in earnest. However, after completing a portion of the project, the weekend warrior will often realize that additional materials and/or tools are needed to complete the project. (At this point, it is not uncommon for the so-called weekend warrior to utter and/or use various expletives.)

Our weekend warrior will generally then proceed on another purchasing mission, many times to a store that is different from the first store, where additional items will be purchased. Not sure of the exact amount of materials or tools needed, the weekend warrior will make a best guess. However, this is only a “best guess,” and hence the weekend warrior may often need to make repeat trips for additional materials and/or tools to complete the project In some, but unfortunately more than a few of these occasions, it is not uncommon for there to ultimately be four, five, or more trips to various hardware stores in the same day. (The present applicants, however, disclaim any personal knowledge of such occurrences.) At some point, it may be, and more often than not is the case, that excess purchases are made simply in the attempt to prevent the seemingly endless repetitive purchasing missions.

These repetitive purchasing missions require the consumer to spend additional time and money, and of course effort, completing the project, along with generally causing, at least in some, if not all instances, a great deal of frustration. In addition, the first store often loses revenue, since the subsequent purchasing missions may take place at different stores that are chosen for convenience. For example, subsequent purchases may be conducted at stores that are solely selected because they are closer to the consumer's home.

Accordingly, a need exists for a system that enables a person to identify all of the materials and tools that are needed for a home improvement project prior to starting the project. In addition, a long-felt need exists for a system which enables purchases to be contemplated and/or made in proximity, at least temporally, to the conception or idea of the project.

### BRIEF DESCRIPTION OF THE DRAWINGS

A more complete understanding of the present invention may be derived by referring to the detailed description when considered in connection with the following illustrative Figures, which may not be to scale. In the following Figures, like reference numbers refer to similar elements throughout the Figures.

FIG. 1 is a schematic view of an overview of various features of an embodiment of the home improvement system in accordance with the present invention;

FIG. 2 is a schematic view of, for example an Internet implication of certain aspects of the home improvement system in accordance with various aspects of the present invention;

FIG. 3 is a further schematic view of further aspects of the design and purchase components of the home improvement system in accordance with various aspects of the present invention;

FIG. 4 is a further schematic view illustrating various design and solution oriented features of the design component of the home improvement system in accordance with various aspects of the present invention; and

FIG. 5 is an exemplary printout of a shopping list which may be generated through use of the home improvement system in accordance with various aspects of the present invention.

### DETAILED DESCRIPTION

Subject matter of the non-provisional patent application entitled “Methods And System For The Collection and Delivery of Information Specific Data” by inventors Michael Heisler et al., filed on the same date herewith, is hereby incorporated by reference.

The present invention may be described herein in terms of various software and hardware components and processing steps. It should be appreciated that such components may be realized by any number of software and hardware components configured to perform the specified functions. For example, the present invention may employ various software components for different types of design projects, e.g., a separate software component for kitchen design, sprinkler design, deck design, shelf design, and the like, which may carry out a variety of functions under the control of one or more software applications or other control components. In addition, those skilled in the art will appreciate that the present invention may be practiced in any number of interactive contexts, such as the Internet, and that the preferred embodiment described herein is merely one exemplary application for the invention. Further, it should be noted that the present invention may employ any number of conventional techniques for database storing and retrieving, displaying text and graphics, printing output, sending files, and the like. Such general techniques that may be known to those skilled in the art are not described in detail herein.

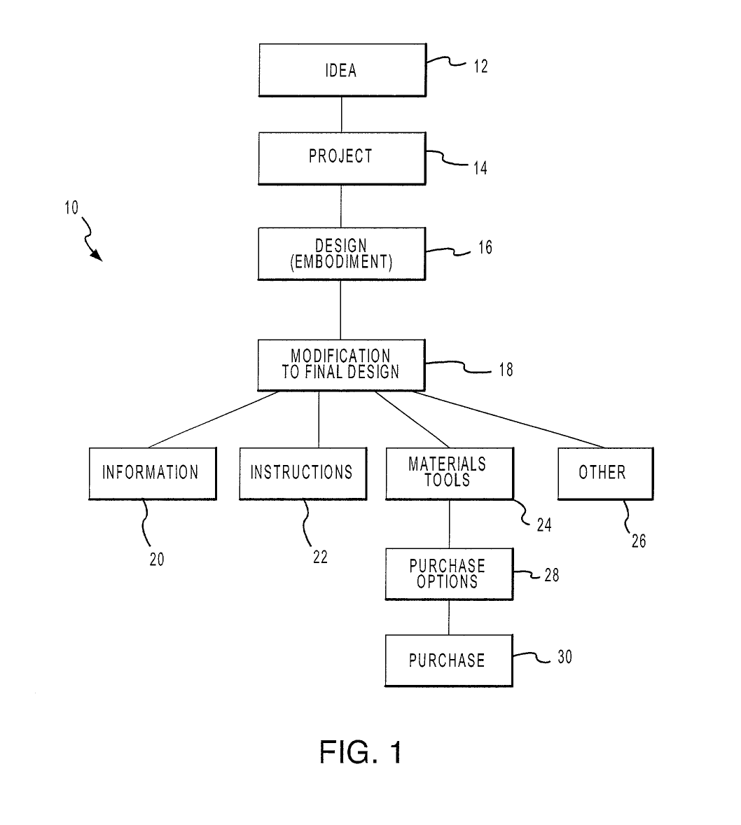

As discussed above, a need exists for a system that enables a person to identify all of the materials and tools that are needed for a home improvement project prior to starting the project. In accordance with the present invention, a web-site is suitably configured to provide for an on-line, interactive home improvement system. In this context, a home improvement system contemplates a system which enables an idea to be realized into a design and then information with respect to how to build the design, the materials needed to complete the project, and information on purchasing those materials provided to the user. In accordance with various aspects of the present invention, purchase of the materials is also contemplated and/or completed through use of the system. While the way in which the present invention can be utilized will be discussed in further detail hereinbelow, with momentary reference to FIG. 1, the present invention presents a home improvement system which enables a user to take a project idea through to completion of purchase of necessary tools and materials without the need for substantial repetitive purchases. This offer is both a convenience to the consumer, as well as a benefit to retailers who are able to capture more of the sale in the initial purchasing mission.

For purposes of illustration, and for illustration purposes only, with reference to FIG. 1, consider that an idea 12 relates to a user's desire to install a home sprinkler system in the user's yard. As is known in many parts of the United States, automatic sprinkler systems may be used for the irrigation of plants, yards, i.e., grassy areas, and other foilage which may be used to landscape a particular area. The particular details of the landscaping system and the components of the sprinkler system are generally beyond the scope of this application and will not be described in great detail herein. However, suffice it to say that those components are generally known and that use of system 10 of the present invention facilitates the identification of those components, the design and modification of a project which embodies those components, and the facilitation of purchase of those components as will be herein described. It should be appreciated that idea 12 can be any idea relating to home improvement projects and that the aforementioned sprinkler system idea is but one example. Other examples, as will be explained in greater detail hereinbelow, may include shelf systems, outdoor decks, painting projects, wallpapering projects, and all other now known or hereafter devised home improvement projects.

As will be understood by those who are familiar with home improvements projects, once an idea is formulated, perhaps in many instances better characterized as a need, the need takes shape in terms of a project, namely project 14, which transforms the idea into an action plan. In the context of this illustrated embodiment of a sprinkler system, the idea or need for a sprinkler system can be transformed into an action plan for how the sprinkler system will be laid out and the particular purposes for which the sprinkler system is going to be designed to meet. For example, the transformation of the idea into the project may involve identifying the particular areas of one's yard which need to be watered, the type of watering which might need to be accomplished, etc.

Once the project is defined, the project must be transformed into an embodiment that is a tangible expression of the action plan which combines elements of the purpose for which the project is to be used, as well as the components which would be necessary to accomplish those purposes. In the context of a sprinkler system, for example, the necessity of providing a control system which can be electronically and hydraulically connected to the home electrical and water system is important. The particular placement of watering devices, for example, spray nozzles, drip valves, etc., the series of conduits, electrical, hydraulic and others, need to be identified and mapped to enable the system to carry out the aforementioned purposes. Within the context of the home improvement system 10 of the present invention, in accordance with its various aspects, the design is preferably facilitated through an interactive approach which enables the user to set forth particular parameters and through use of various software tools manipulate those parameters into the expression of a design (embodiment) which illustrates how those parameters are to be arranged. In order for the system to facilitate changes which might occur in this design process, the system also provides for ready and easy modification of the design which is facilitated through appropriate software and software tools which enable manipulation and modification of the design once initially expressed.

Once modified, the design can be finalized and, with respect to the final design, the home improvement system 10 of the present invention facilitates a variety of products which can be useful in performance of the home improvement project. For example, with respect to the final design, various information 20 pertaining to the final design, its characteristics, its performance and/or limitations may be provided. Instructions 22 may be provided which enable the user to carry out the project. For example, instructions may include “how to” information which provides the user with a detailed description of how various steps of the project will be carried out. Importantly, system 10 also provides the user with a detailed listing of materials and tools which will be necessary to complete the home improvement project. In this illustrative example, such materials and tools may include PVC piping, saws, shovels, pipefitting materials, sprinkler components, and the like. Importantly, these materials and tools should take into consideration difficulties which may be encountered along the project and geared towards minimizing the need to purchase additional materials. At the same time, such materials and tools should not be calculated in such a way that unnecessary tools and materials are not purchased.

While the particular parameters and permissible excesses with respect to materials and tools will differ from project to project, in general, the present system minimizes the need for excess materials and tools and maximizes the likelihood that necessary tools and materials will be obtained in a single purchasing mission. The way in which the system accomplishes this will be described in greater detail hereinbelow, but suffice it to say that system 10 enables a user to conveniently and easily take the idea 12 to the necessary tools and materials in a convenient and efficient manner.

Depending on the particular idea 12, which can be transformed into project 14, various other information 26 may also be provided. In certain instances, such other information may relate to warnings, code requirements, or particular permits which might be necessary for a particular project.

In accordance with various aspects of the present system, with the system thus generating the necessary tools and materials, information with respect to purchase options with respect to those tools and materials can be provided to the user. In connection with the non-limiting sprinkler example, for example, certain tools may include yard tools which facilitate the preparation of trenches into which various piping constructs may be placed. If the user is already in possession of those tools, then obviously the user need not purchase those tools in connection with this project. In addition, in various cases, other tools and/or materials for a particular project may already be in the possession of the user and thus not needed for completion of the project. Moreover, various tools and materials may be able to be purchased from various locations, thus enabling the user to select based upon various criteria. For example, although a store at location X may have a more convenient location to the user, prices available at that store may be in excess of a store at a less convenient location Y which has more attractive pricing for the various materials or tools necessary. Through an interactive process, system 10 enables the user to arrive at the necessary materials and tools at the most attractive pricing and location to facilitate purchase.

In the context of the purchase block 30, purchase can occur in accordance with various aspects of the present invention by way of an e-commerce purchase. As will be explained in greater detail below, having thus arrived at the necessary materials and tools and the appropriate location where such tools and materials can be obtained, the user may simply enter into a transaction with the store, such as via the Internet, to facilitate the purchase. In accordance with various other aspects of the invention, the purchase may be consummated in a non-electronic manner. For example, the purchaser may simply drive or otherwise transport themselves to the location and purchase at that location in a conventional manner the necessary materials and tools. In any event, having thus arrived at the necessary materials and tools through use of the system 10, the purchase minimizes the need for repetitive purchases of the design described hereinabove.

Although the present invention may be provided in conjunction with a variety of delivery media such as an off-the-shelf CD, a standalone computer, and the like, the present invention is conveniently described below in connection with a globally accessible web-site.

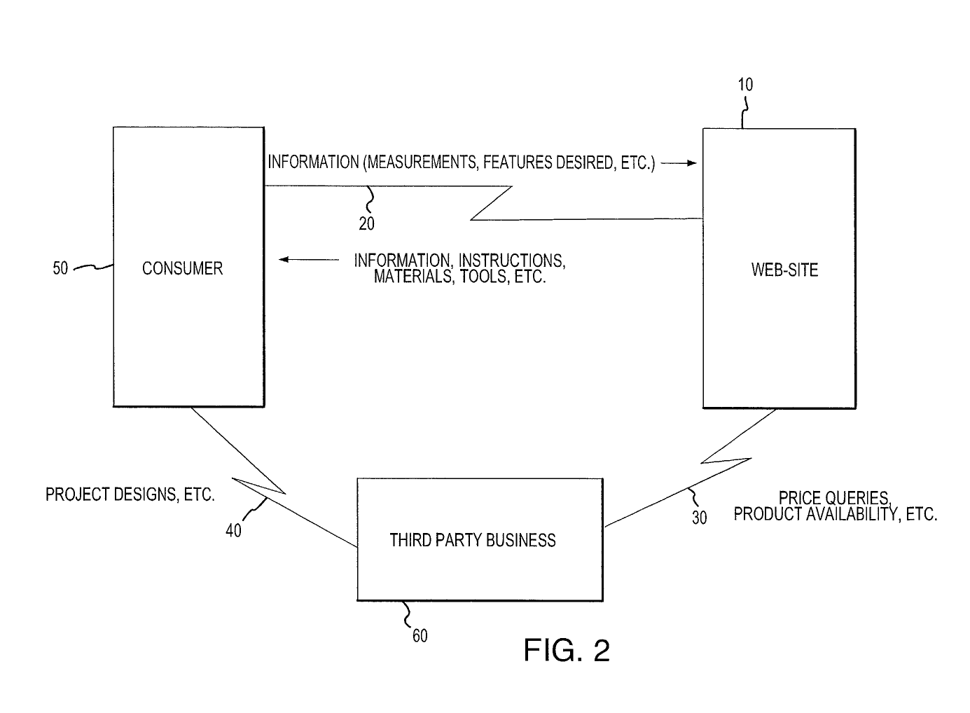

In accordance with an exemplary embodiment, with reference to FIG. 2, an on-line, interactive home improvement system 10 can be accessed by the consumer through a data connection 20. The consumer can access the web-site from a home computer 50 by using any conventional Internet browser such as Netscape Navigator, Microsoft Internet Explorer, and/or the like. The browser can be used to display the various web-pages of the web-site on home computer 50. Data connection 20 may comprise any of a variety of known Internet connections such as a traditional public switched telephone network (PSTN), a T-1 line, an integrated services digital network (ISDN), a coaxial cable television system (i.e., cable television line) and a combination of the like.

In accordance with one aspect of the present invention, home improvement system 10 may be connected to third party system 60 by data connection 30 or alternatively, home computer 50 may be connected, for example via data connection 40, directly to third party system 60. Data connections 30, 40 similar to data connection 20, may also comprise any of a variety of known Internet connections. However, it should be appreciated that in accordance with various aspects of the present invention, information may be conveyed in a non-electronic manner to third party 60. In the context of a home improvement system, third party system 60 suitably comprises the computer system of a third party, home improvement related business such as Home Depot, Orbit Irrigation Products, the Scotts Company, and the like.

In accordance with another aspect of the present invention, briefly mentioned above, system 10 is connected to third party system 60 by data connection 40. Like data connections 20 and 30, data connection 40 can comprise any of a variety of known Internet connections. However, home computer 50 may not be connected to third party system 60. Instead, information may be conveyed in a non-electronic manner to third party system 60.

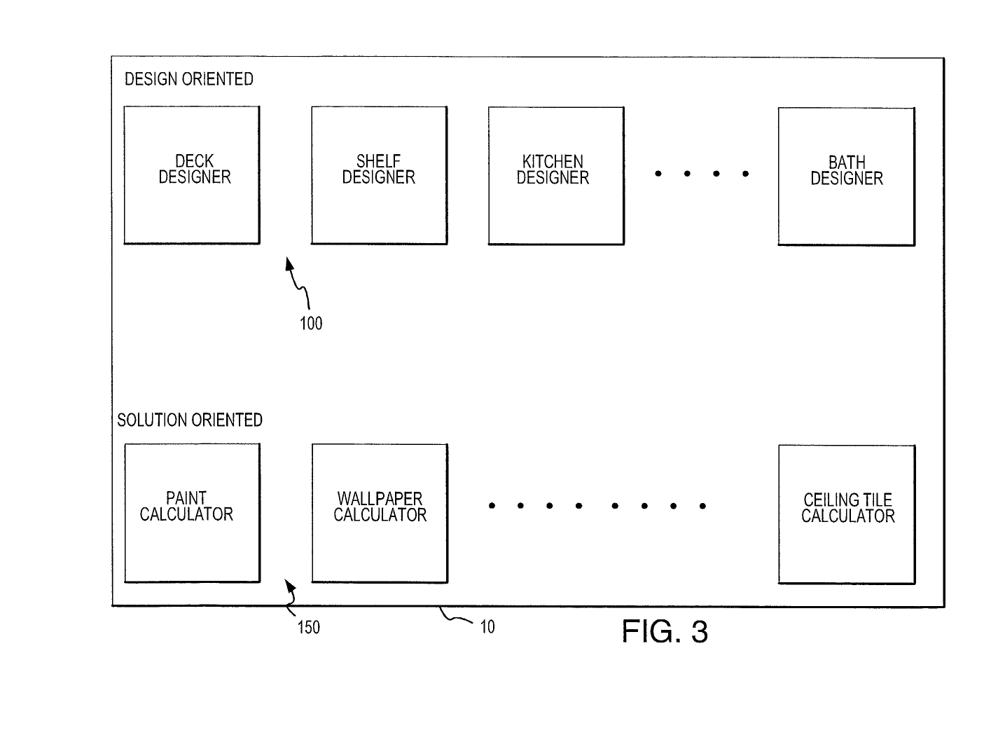

With reference to FIGS. 1 and 3, home improvement system 10 suitably includes a toolkit or collection of software tools to facilitate transforming idea 12 into design 16. In one embodiment of the present invention, there may be a web-site containing a collection of design-oriented software tools 100 and solution oriented software tools 150. Design oriented software tools 100 may be used to design a home improvement project and to identify the materials and tools needed for the home improvement project. For example, design oriented software tools 100 may comprise a software tool for designing a deck, a set of shelves, a kitchen, a bathroom and the like. Each of design oriented software tools 100 is available from system 10 by accessing the web-site for system 10. It will be appreciated that this allows for the user to access and design the home improvement project in the convenience of the user's home. This also allows for the user to have immediate access to features of the home for ease of measuring features, counting windows, and the like, so that the user can easily provide accurate information to the design.

The specific features of the various design oriented software tools which may be useful in the context of the present invention will not be described in detail herein, as any now known or hereafter devised tool may be utilized. In general, however, such tools facilitate transformation of idea 12 into design 16.

Solution oriented software tools 150 may be suitably used to calculate the solution to a problem related to a home improvement project. For example, if the home improvement project is to paint a room of the house, then one of the problems that arises is the calculation of the amount of paint needed to paint the room. The user can access the proper solution oriented tool for calculating paint by navigating through the web-site of system 10. For example, with respect to room painting, the paint calculating tool can be accessed and the tool will then preferably prompt the user for specific measurements which can be readily made by the user accessing the appropriate room and then the specified information can be supplied to the tool 150. In the context of various aspects of the present invention, it should be appreciated that such access can be readily facilitated. That is, where the home computer is in the home and the room which is to be painted is also in the home, such measurements can be made at the time, or if desired prior to, the consumers access to web-site 10. In any event, the amount of paint which may be needed can be calculated accurately by the solution oriented tool. Other examples of solution oriented software tools 150 include software tools for calculating the amount of wallpaper needed, calculating the amount of ceiling tiles needed, calculating the amount of concrete needed and the like. Each of solution oriented software tools 150 is available from system 10 by accessing the web-site for system 10. It should be appreciated that this allows for the user to access and calculate the supplies needed for a home improvement project in the convenience of the user's home. As discussed above, this will also allow for the user to have immediate access to features of the home for ease of measuring, counting windows, and the like, so that the user can provide accurate information to the calculation.

The specific features of the various solution oriented software tools which may be useful in the context of the present invention will not be described in detail herein, as any now known or hereafter devised tool may be utilized. In general, however, such tools facilitate transformation of idea 12 into design 16

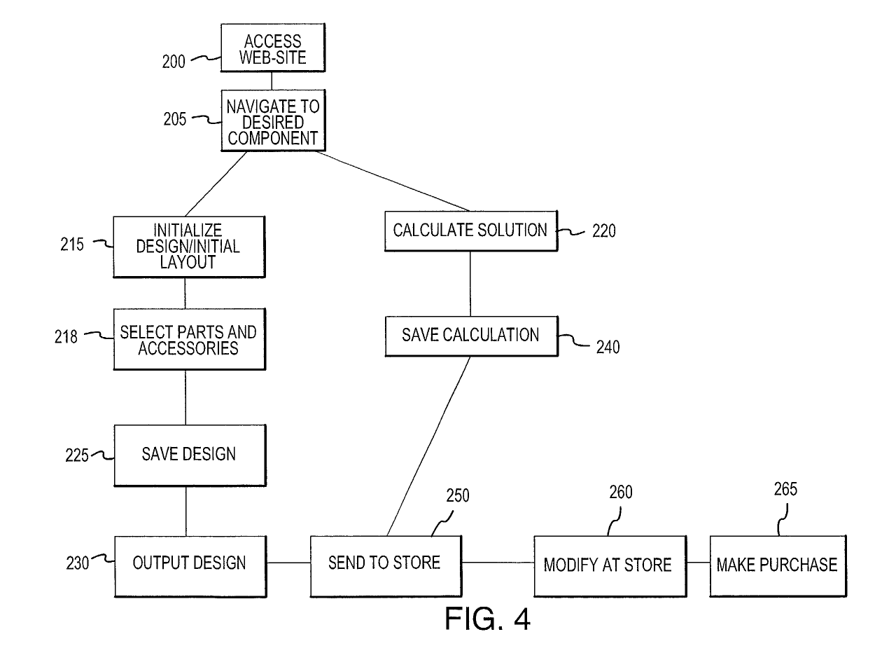

With reference now to FIG. 4, a user accesses home improvement system 10 of the present invention in various ways as are well known in the art (step 200). Preferably, the user enters the web-site of system 10 by using a web-browser or similar application. The user may navigate to the web-site by entering the Uniform Resource Locator (“URL”) directly into the browser. Alternatively, the user may use a search engine such as Yahoo or an already saved bookmark to access the web-site or any other known or hereafter devised technique for accessing a web-site.

Depending on the particular idea 12 which can be transformed into a project 14, the user can navigate to the desired design-oriented software tool 100 or solution-oriented software tool 150 (step 205) that may be used to facilitate the transformation of idea 12 into design 16. In the context of the aforementioned sprinkler system project, the user can navigate to design oriented software tool 100 that corresponds to the tool that facilitates the transformation of the sprinkler system project into a sprinkler design.

Upon navigation to the desired software tool, the user can begin transforming the project into a design. In the context of the illustrated embodiment of a sprinkler system, this transformation may involve the user providing particular parameters and measurements to facilitate the software tool in creating the design. In accordance with one aspect of the current invention, by following the directions, and using the drag and drop features of the software tool of system 10, the user can graphically lay out their property perimeter, home and landscape features (step 215). As needed, the user can conveniently make measurements of their home. For example, the user can provide measurements of the main service water line, static water pressure, flow capacity and other property measurements as they are known in the art.

By using the list of sprinkler products available, the user can select the sprinkler parts and accessories that are desired for their sprinkler project (step 218). Alternatively, system 10 can make suggestions for parts and accessories which can be accepted or declined by the user. For example, the user can call upon options which may be advantageously provided by the particular software tool chosen. In the illustrated sprinkler design project, for example, such options may relate to different types of sprinkler heads which may be available, such as drip systems, sprayers and the like.

Once completed the design can be finalized and preferably is saved in some form (step 225). In certain applications and for certain projects actually saving the design in a conventional computer fashion may not be necessary, instead the finalized design will simply be utilized to facilitate further handling by system 10. For example, the design may simply be output (step 230) to enable its use by the consumer, third parties or others. In this manner, for example various items relative to the design may be provided, such as instructions, how-to information, other information, bills of materials or tools, shopping lists or any other output that may be useful to the consumer in completing the project.

In accordance with certain aspects of the present invention the design is actually sent to a third party store (step 250). Once received it can be modified (see for example step 260), for example to reflect the store's then available inventory, or to enhance the design or to provide a less expensive alternative. Preferably, once received by the store, the consumer either literally or electronically goes to the store to make the purchase of the necessary tools, materials or other items (step 265). For example, in accordance with certain aspects of the present invention, the purchase (step 265) is simply made electronically. The items purchased in such a case may be picked up by the consumer, or alternatively delivered to the consumer by the store. In any event, the materials, tools and other items are advantageously arrived at through the use of the inventive system enable the reduction, an optimally the elimination of repetitive purchases.

With continued reference to FIG. 4, use of the solution oriented tools of the present invention can be made in a similar fashion. For example, the user may access the particular solution tool desired, for example the paint calculation tool (step 220). Once utilized, the solution may be save or utilized (step 240) to generate a usable output which is helpful to the consumer. This output can be manually or electronically by the user. For example, in accordance with various aspects of the present invention, the output calculated through use of the system may be sent to the store and the necessary items needed, for example paint, purchased (step 265). As with use of the design oriented tools, the calculation may be modified at the store (step 260) in light a number of factors, such as inventory, cost etc.

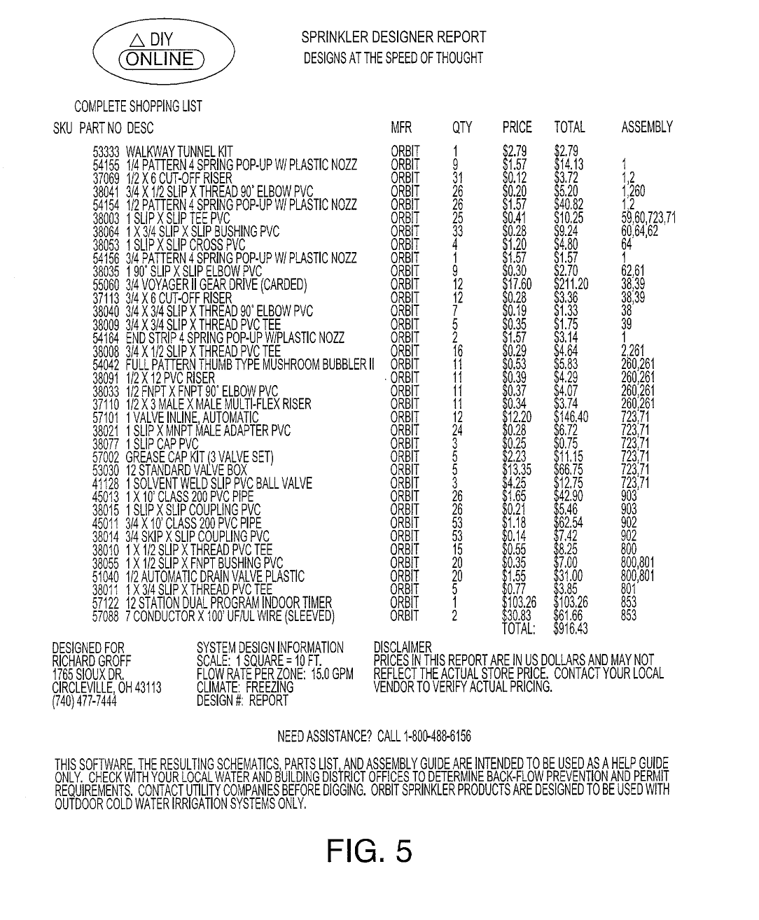

In accordance with various aspects of the present invention, one of the outputs may comprise a shopping list. With reference now to FIG. 5, an exemplary shopping list for use in connection with a sprinkler design is set forth. Such a shopping list is preferably configure to simplify the shopping experience, and thus may advantageously provide part numbers, product descriptions, manufacturer information, quantities needed, price, assembly references and the like. It should be appreciated, however, that all, few or none of these feature may be provided for a particular project. Moreover, additional items of interest or assistance to the consumer may also be provided. The shopping list enable the ready purchase of the necessary materials. In this manner repetitive purchase are minimized and consumer happiness enhanced.

The design aspects of the present invention are advantageously provided to facilitate ease of use. For example, in accordance with various preferred aspects of the invention, as previously noted, the customer accesses a web-site to gain access to the design tools. This access, preferably, enables the formation of an interactive environment in which information can be requested and supplied. For example, the customer can request and provide information, and the web-site can respond. Similarly, the web-site design tools can request and provide information to the customer. The precise manner in which this interactive design mode is facilitated can be chosen as may be desired. However, such interaction should result in sufficient information being obtained so that appropriate outputs can be enabled. These outputs result, in general, from the suitable manipulation of the information. Such outputs can be tailored as may be desired, but in general include outputs which facilitate the purchase of the necessary tools, materials and other items needed to complete the project.

Various options can be provided to the consumer relative to such purchases. For example, in connection with those aspects of the present invention where the purchase is completed electronically, the user may be provided various different price options from various different vendors of the necessary tools, materials and other items. For example, having arrived at a suitable shopping list, the consumer may choose to purchase the necessary items from various online shopping outlets. Preferably, in accordance with various aspects of the present invention, the consumer will be automatically linked to such outlets, or a variety of such outlets. In addition in connection with certain projects it may be desirable to facilitate communication between the consumer and the vendor relative to the purchase, such as to facilitate further information from the vendor relative to the project, to facilitate financing of the purchase, or any other communication that may enable the easy completion of the project and/or purchase. Such communication may be provided in any manner now known or hereafter devised. For example, e-mail or chat-like communication may be facilitated.

For consumers wishing to make purchases in a non-electronic manner, various options may also be provided. For example, with given demographics, price alternative from various vendors may be provided. Directions to the various vendors may also be provided. In certain instances, vendor inventory and/or availability may be provided.

The purchase being completed, the consumer through use of the inventive home improvement system is, in accordance with various aspects of the present invention, then guided through the building or other actions necessary to complete the project. That is, outputs in the form of instructions, or “how-to” information are advantageously generated through the use of the system. These instructions, preferably tied to the necessary tools, materials or other items needed, enable the completion of the project.

As should now be clear in light of the foregoing description of preferred embodiments of the present home improvement system, an idea can be transformed into a project. The necessary materials, tools and other items needed for the project can be derived and purchase facilitated. With the need for repetitive purchases minimized, and optimally eliminated, the project can be completed and the consumer's sanity preserved and happiness enhanced.

The present invention has been described above with reference to an exemplary embodiment. However, those skilled in the art will recognize that changes and modifications may be made to the exemplary embodiment without departing from the scope of the present invention. For example, the various components of the home improvement system may be implemented in alternate ways depending upon the particular application or in consideration of any number of cost functions associated with the operation of the system, e.g, the software tools may be configured in different sequences or to provide different design projects. In addition, the techniques described herein may be extended or modified for use with various other applications, such as, for example, a clothing design web-site. These and other changes or modifications are intended to be included within the scope of the present invention.

What is claimed is:

1. A method for facilitating a transaction between a buyer and a seller comprising the steps of:
formulating an idea for a home improvement project;
interactively transforming the idea into a design of the home improvement project;
providing a pull list for the project to the buyer, the pull list comprising a complete list of materials for completing the project;
providing information about a preferred seller of the materials to the buyer, wherein the preferred seller is selected from a plurality of sellers; and
purchasing the materials from the preferred seller.

2. The method of claim 1, wherein:
in the step of providing a pull list for the project, the pull list further comprises a complete list of tools for completing the project;
the step of providing information further comprises providing information about a preferred seller of the tools to the buyer; and
the step of purchasing further comprises purchasing the tools from the preferred seller.

3. The method of claim 1, wherein in the step of providing information, the preferred seller is selected based on the location of the buyer.

4. The method of claim 1, wherein the step of providing information comprises providing information about a plurality of preferred sellers.

5. The method of claim 1 further including the step of interactively revising the design of the home improvement project.

6. The method of claim 1 further including the step of providing localized information to the buyer, wherein the localized information includes details on building code requirements, building permits, and warnings.

7. The method of claim 1 further including the steps of:
providing a coupon to the buyer; and
using the coupon to keep track of the transaction.

8. The method of claim 1 further including the steps of providing the pull list to the preferred buyer.

9. The method of claim 8 wherein the purchase is completed in an electronic manner.

10. The method of claim 8 further including the step of sending the materials to the buyer.

11. The method of claim 8 further including the step of pulling the materials and having the materials waiting for the buyer at a store.

12. The method of claim 8 further including the step of contacting the buyer to complete the transaction.

13. In an interactive computer system, a method of generating a design for a home improvement project comprising the steps of:
selecting a home improvement project type;
displaying a default set of parameters for the home improvement project type;
optionally, modifying the default set of parameters for the home improvement project;
generating a pull list containing a complete list of materials needed to complete the home improvement project;
generating a detailed design of the home improvement project; and
generating a list of preferred sellers, wherein each of the sellers may be able to provide the materials needed for the home improvement project.

14. The method of claim 13 further comprising:
entering additional parameters for the home improvement project; and
optionally, modifying the additional parameters for the home improvement project.

15. The method of claim 13 further comprising:
displaying a default graphical representation of the home improvement project; and
optionally, interactively modifying the graphical representation of the home improvement project.

16. The method of claim 15 further including the step of automatically modifying the graphical representation of the home improvement project based on the modified parameters.

17. The method of claim 13 wherein:
in the step of generating a pull list, the pull list further comprises a complete list of tools needed to complete the home improvement project; and
in the step of generating a list of preferred sellers, each of the sellers may be able to provide the tools needed to complete the home improvement project.

18. The method of claim 13 further including the step of providing localized information including details on building code requirements, building permits, and warnings.

19. A computerized, interactive home improvement system comprising:
a plurality of software tools, said software tools configured to allow a user to perform the following steps:
formulating an idea for a home improvement project;
interactively transforming the idea into a design of the home improvement project;
generating a pull list for the project, the pull list comprising a complete list of materials for completing the project;
a seller database, wherein each of the software tools is configured to access the seller database to generate a list of preferred sellers of the materials for completing the home improvement project; and
wherein the home improvement system is associated with a web-site.

18. The system of claim 17 wherein the software tools comprise design oriented software tools and solution oriented software tools.

19. The system of claim 17 further comprising a user database, wherein each of the software tools is configured to access the user database to store and retrieve information collected from the user.

20. The system of claim 17 wherein the pull list further comprises a complete list of tools for completing the project.

21. A computer program product comprising:
a computer readable medium having computer readable program code embodied therein that handles facilitating the designing of a home improvement project, the computer readable program code configured to perform the steps comprising:
identifying a home improvement project type;
providing a default set of parameters for the identified home improvement project type;
enabling optional modification of the default set of parameters;
finalizing the default set of parameters;
generating a pull list containing a complete list of materials needed to complete the home improvement project;
generating a detailed design of the home improvement project; and
generating a list of preferred sellers, wherein each of the sellers may be able to provide the materials.

22. The computer program product of claim 21 having further computer readable program code for performing the steps of:
entering additional parameters for the home improvement project; and
enabling optional modification of the additional parameters.

23. The computer program product of claim 21 having further computer readable program code for performing the steps of:
displaying a default graphical representation of the home improvement project; and
enabling optional modification of the graphical representation.

24. The computer program product of claim 23 having further computer readable program code for performing the step of automatically modifying the graphical representation of the home improvement project based on the modified parameters.

25. The computer program product of claim 21 having further computer readable program code for performing the step of providing localized information including details on building code requirements, building permits, and warnings.
